(19) United States
(12) Patent Application Publication
(10) Pub. No.: US 2023/0394905 A1
(43) Pub. Date: Dec. 7, 2023

(54) Food and Beverage Production System

(71) Applicant: James P Janniello, Sarasota, FL (US)

(72) Inventor: James P Janniello, Sarasota, FL (US)

(21) Appl. No.: 18/330,344

(22) Filed: Jun. 6, 2023

Related U.S. Application Data
(60) Provisional application No. 63/328,231, filed on Apr. 6, 2022.

(51) Int. Cl. G07F 13/06; A47J 31/52

(52) U.S. Cl. CPC G07F 13/065; A47J 31/521

(57) ABSTRACT

A recipe is obtained from a user and a mixing machine is configured based on the recipe. A beverage is mixed based on the recipe and dispensed. The use of the recipe by the mixing machine is monitored and compensation for use of the recipe is determined based on the monitored use and the configuration of the mixing machine.

### TECHNICAL FIELD

The present application relates generally to the mechanical, electrical, electronic, and computer arts, and more specifically, in one example, to a food and beverage production system.

### BACKGROUND

Beverages, including sodas, juices, coffees, lattes, milkshakes, wines, cocktails, and the like, are often mixed by hand, mixed by machine, or by a combination of hand and machine. Similarly, ingredients for food items are often mixed by hand, mixed by machine, or by a combination of hand and machine. The mixing of food ingredients and beverages may be performed in accordance with a custom list of ingredients, mixed using a particular technique (such as shaken or stirred), mixed and/or served at specific temperatures, and the like. On occasion, a barista or bartender may have a special recipe (including a list of ingredients, a special technique, a special set of steps, and the like) to mix a beverage that receives broad acclaim by connoisseurs of the particular type of beverage. In such cases, the owner of the recipe may wish to conceal and protect the recipe from disclosure (including public disclosure). Chefs and cooks may similarly have a special recipe (including a list of ingredients, a special technique, a special set of steps, baking temperatures, serving temperatures, and the like) for preparing food items, meals, desserts, and the like.

Machines for mixing beverages are generally available and used to perform mixing based on prescribed recipes. For example, the Mixo Two by Mixologiq of Paris, France accommodates twenty bottles of spirits, liqueurs, syrups, and fruit juices, and mixes cocktails according to recipes that are entered via a user interface and stored within the mixing machine. Similarly, machines for automatically producing food items, such as fresh bread, are generally available.

### BRIEF DESCRIPTION OF THE DRAWINGS

Some embodiments are illustrated by way of example and not limitation in the figures of the accompanying drawings in which:

FIG. 1 is a block diagram of an example food and beverage production system, in accordance with an example embodiment;

FIG. 2 is a block diagram of an example apparatus for a food and beverage production system, in accordance with an example embodiment;

FIG. 3 is a flowchart for an example food and beverage production method, in accordance with an example embodiment; and

FIG. 4 is a block diagram of a machine within which instructions may be executed for causing the machine to perform any one or more of the methodologies discussed herein.

### DETAILED DESCRIPTION

In the following detailed description of example embodiments, reference is made to specific examples by way of drawings and illustrations. These examples are described in sufficient detail to enable those skilled in the art to practice these example embodiments, and serve to illustrate how the invention may be applied to various purposes or embodiments. Other embodiments of the invention exist and are within the scope of the invention, and mechanical and other changes may be made without departing from the scope or extent of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

Generally, systems and methods for producing food, beverages or both are disclosed. Example embodiments enable users to submit recipes to a food and beverage production system where the confidentiality of the recipe is maintained and where the creator(s) of the recipe, the owner(s) of the recipe, the rights owner(s) of the recipe, or any combination of the foregoing receives compensation in return for use of the recipe. Food and beverage products created using the recipe may be marketed via the food and beverage production system or via other means to generate royalties or other licensing fees for recipe creators and/or owners.

In one example embodiment, a user, such as a barista, a bartender, a retail customer, and the like, can submit a recipe for mixing a beverage via a secure interface of the food and beverage production system. Similarly, a user, such as a chef, a retail customer, and the like, can submit a recipe for producing (such as mixing, baking, broiling, and the like) a food item via a secure interface of the food and beverage production system. In one example embodiment, the recipe is submitted to the food and beverage production system via a blockchain. The blockchain assists in protecting the security, rights, and privacy of the recipe, assists in the transfer of ownership and/or rights of the recipe, maintains information related to computing royalty and licensing fees, and the like. The food and beverage environment also enables the submitted recipe to be distributed to beverage mixing machines in a secure manner, such that the contents of the recipe are protected from unauthorized inspection. For example, the recipe may be encrypted prior to or in conjunction with incorporation into a blockchain.

In one example embodiment, the creator of the recipe, the submitter of the recipe, the owner of the rights to the recipe, an authorized user, or any combination of the above is compensated for submission of the recipe, permission to use the recipe, usage of the recipe or any combination of the foregoing. For example, the submitter of the recipe may receive compensation in exchange for ownership rights of the recipe, the submitter of the recipe may receive a royalty or licensing compensation for a right to use the recipe (such as a royalty for each serving of the beverage, a fee for unlimited use of the recipe during a specified time period, and a fee for unlimited use of the recipe on a given machine during a specified time period), and the like.

In one example embodiment, the submitted recipe is made available for selection via a user interface associated with, for example, a beverage mixing machine or other food and beverage production machine. In one example embodiment, details of the submitted recipe are protected and not accessible by unauthorized users, unauthorized systems, or both. For example, a purchaser of the beverage, a barista preparing the beverage via a beverage mixing machine, and the like may be denied access to the details of the recipe (such as an unencrypted version of the recipe). In one example embodiment, details of the submitted recipe, such as one or more of the ingredients, the mixing technique, the production steps, the serving temperature, and the like, are not revealed to any unauthorized individual, any unauthorized system, or both. For example, once submitted, the unencrypted recipe may only be accessible by the electronics of a given beverage mixing machine. The beverage mixing machine receives an encrypted version of the recipe via, for example, a blockchain and decrypts the recipe within a hardware device of the beverage mixing machine. In one example embodiment, the unencrypted recipe is only accessible by an authorized user(s), such as an authorized administrator; the recipe creator; the recipe submitter; a current recipe owner, rights owner, licensee, licensor, and the like; or any combination of the foregoing.

In one example embodiment, the food and beverage production system enables users, including a user unauthorized to access details of a recipe, to customize the recipe without the details of the recipe being revealed to the user. For example, the user may specify that the original recipe should be sweetened by adding a sweetener, may specify one or more ingredients to add to the recipe (regardless of whether the recipe is known by the user to contain or not contain the specified ingredient), may specify one or more ingredients to exclude from the recipe (regardless of whether the recipe is known by the user to contain or not contain the specified ingredient), may specify a particular serving temperature, and the like. For example, a person with an allergy to peanuts may customize the recipe to exclude peanuts. The customized recipe may then be stored for future use by the food and beverage production system in, for example, the beverage mixing machine, a food and beverage processing server, and the like. In one example embodiment, despite the recipe being customized by the user, the royalty and/or licensing terms of the original recipe will be applied to the customized recipe.

In one example embodiment, the creator, the submitter, the owner or any authorized user associated with the recipe may develop their own brand under which the recipe and/or corresponding beverage and/or food item is marketed and advertised. The marketing and advertising may be conducted via an interface of the food and beverage production system. A user of the beverage mixing machine, such as a bar owner, a bartender, a barista, a retail customer, and the like, may then select the advertised recipe/beverage/food item via a user interface associated with the mixing machine. In the situation where the recipe owner is due, for example, a per-serving royalty or other royalty/licensing fee, the mixing machine or an associated machine, such as a laptop computer, will credit the recipe owner with an indication of the royalty or licensing fee due (such as a royalty due for one or more servings). The credit may be applied when the servings are purchased, when the beverages are mixed, when the royalty/licensing agreement is executed and the like. In one example embodiment, the credit is applied by adding a block to a blockchain associated with the recipe. In one example embodiment, a blockchain is maintained for each recipe. In one example embodiment, a blockchain is maintained for each combination of recipe and mixing machine.

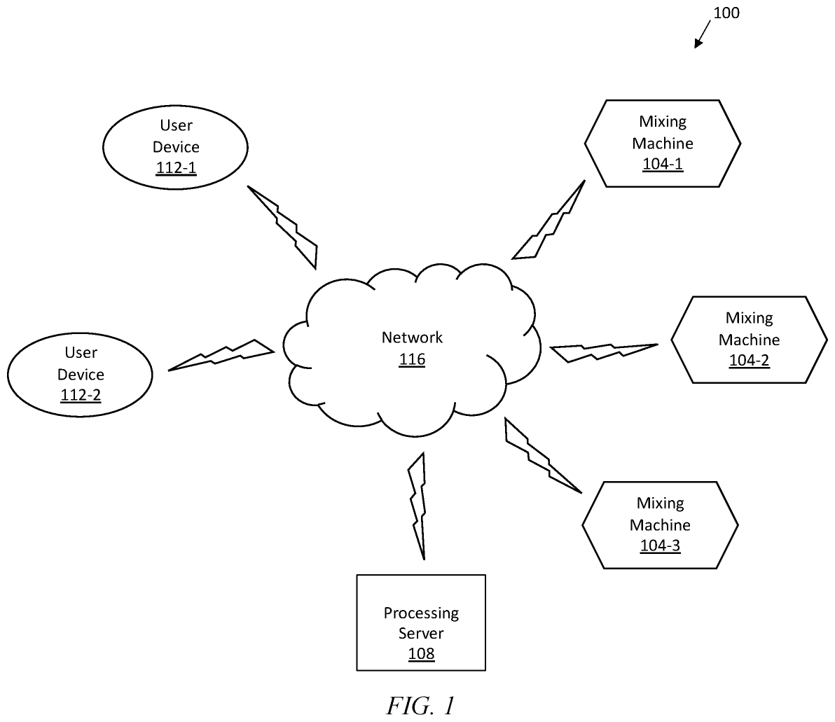

FIG. 1 is a block diagram of an example food and beverage mixing system 100, in accordance with an example embodiment. In one example embodiment, a plurality of mixing machines 104-1, 104-2, 104-3 (referred to collectively as mixing machines 104 herein) communicate via a network 116 with user devices 112-1, 112-2 (referred to collectively as user devices 112 herein) and a food and beverage processing server 108 (also referred to as processing server 108 herein). In one example embodiment, the mixing machine 104-1 includes a user interface that provides functionality similar to that of the user device 112. In one example embodiment, the food and beverage processing server 108 is a component of one or more of the mixing machines 104.

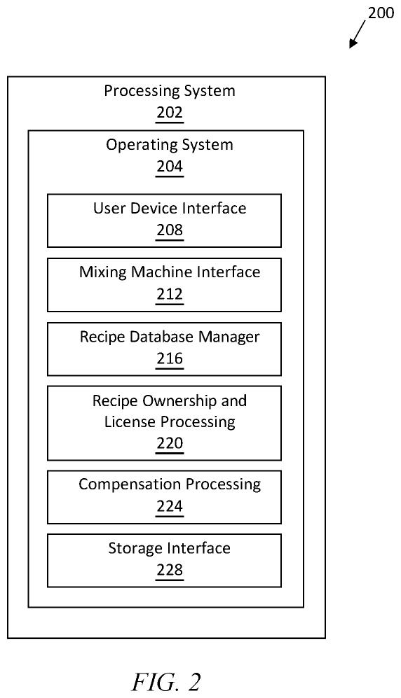

FIG. 2 is a block diagram of an example apparatus 200, in accordance with an example embodiment, for a food and beverage mixing system, in accordance with an example embodiment. The apparatus 200 is shown to include a processing system 202 that may be implemented on a client or other processing device that includes an operating system 204 for executing software instructions.

In accordance with an example embodiment, the apparatus 200 may include a user device interface 208, a mixing machine interface 212, a recipe database manager 216, a recipe ownership and license processing unit 220, and a compensation processing unit 224. In accordance with an example embodiment, the apparatus 200 may further include a storage interface 228.

The user device interface 206 enables a user to submit a recipe to the food and beverage production system 100, track the usage of and compensation for the recipe, customize a recipe, select a recipe for production, and the like. In one example embodiment, the submitted recipe is transferred directly to the food and beverage production system 100 or is transferred to the food and beverage production system 100 via the processing server 108. The submitted recipe is maintained by the recipe database manager 212. In one example embodiment, the recipe is encrypted and maintained in a blockchain associated with the recipe and the user device interface 206 enables a user to encrypt and incorporate the encrypted recipe into the blockchain. If a user is authorized to access data of the blockchain, such as a previously submitted recipe, data that tracks the usage of the recipe, and the like, the user device interface 206 provides access to the information.

In one example embodiment, the user device interface 206 enables a user to select a recipe for mixing at a particular mixing machine 104. The user device interface 206 enables a user to select a stored recipe for mixing at a particular mixing machine 104, customize a stored recipe, select a customized recipe for mixing, and the like.

In one example embodiment, the mixing machine interface 210 receives the recipe blockchain, decrypts the recipe, and provides details of the decrypted recipe to the mixing machine 104. The mixing machine interface 210 also provides feedback from the mixing machine 104 to the food and beverage production system 100 regarding the mixing of beverages that conform to the recipe. For example, the mixing machine 104 may provide feedback regarding the time of purchase or mixing of a beverage using the recipe, the number of servings mixed, the price charged (for determining royalties based on revenue), and the like. In one example embodiment, the mixing machine interface 210 enables a user to select the recipe to be used for mixing a beverage at a particular mixing machine 104. The recipe may be selected, for example, via the client device interface 206, via an interface of the mixing machine 104, via an interface of the processing server 108, via an application running on a smartphone or other client device (received via the network 116), and the like. In one example embodiment, the mixing machine interface 210 is a component of the mixing machine 104. In one example embodiment, the mixing machine interface 210 is a component of the processing server 108.

The recipe database manager 212 manages the submitted recipes. In one example embodiment, the submitted recipes are stored in blocks of blockchains and the recipe database manager 212 provides access to the recipes in the blockchains or provides access to the blockchains for, for example, the mixing machine 104 and/or the user devices 112-1, 112-2. The recipes may be stored in the blockchain via the client device interface 206, via an interface of the mixing machine 104, via an interface of the processing server 108, and the like. In one example embodiment, the recipes are encrypted prior to storage in the blockchain, prior to storage in the recipe database manager 212, or both.

Recipe ownership and license processing unit 214 processes changes in recipe ownership and logs licensing agreements. In one example embodiment, details and terms of the ownership and licensing agreements are maintained in the blockchain corresponding to the recipe.

The compensation processing unit 218 computes the compensation due to the owner and/or rights owner of the recipe. In one example embodiment, the rights to a recipe may be transferred to a new owner in return for compensation. In one example embodiment, the rights to a recipe are licensed to a licensee in return for a per-serving or other type of compensation, such as a per-machine compensation.

It is contemplated that the techniques for mixing beverages using the mixing machine 104 may be applied to other types of machinery for producing different types of food items, such as frozen pizzas, ice cream, condiments, seasonings, and the like.

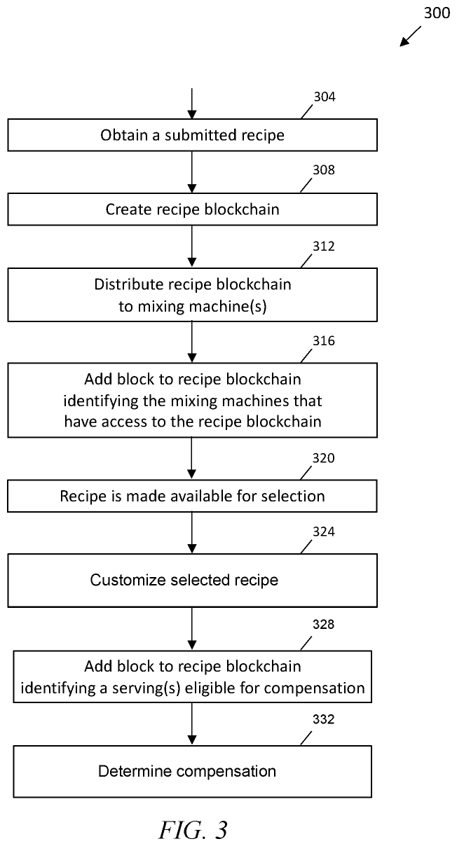

FIG. 3 is a flowchart for an example food and beverage production method 300, in accordance with an example embodiment. In one example embodiment, a user, such as a barista, a bartender, a retail a customer, and the like, submits a recipe for a food and/or beverage via an interface of the user device 112 to the processing server 108, directly to the mixing machine 104, or directly into a corresponding blockchain (operation 304). In one example embodiment, the recipe is encrypted before distribution, such as during operation 304. The user device 112, the processing server 108, or the mixing machine 104 creates a blockchain corresponding to the submitted recipe (operation 308) and the blockchain is distributed to the mixing machines 104, one of the user devices 112, the processing server 108, or any combination of the foregoing in a secure manner, such that the details of the recipe are not disclosed to unauthorized users, unauthorized systems or both (operation 312). A block is added to the blockchain identifying the mixing machines 104 that have received or otherwise have access to the corresponding recipe (operation 316). In one example embodiment, the recipe in the blockchain is encrypted and the mixing machine 104 or an associated device decrypts the recipe prior to use. In one example embodiment, the mixing machine 104 or other device authorized to decrypt the recipe is configured using tamperproof mechanisms, such as secure cryptoprocessors, to decrypt and utilize the recipe, thus protecting the confidentiality of the recipe.

In one example embodiment, the submitted recipe is made available for selection via a user interface associated with a target mixing machine 104 (operation 320). For example, the submitted recipe may be made available via a user interface of the mixing machine 104-1, the user device 112-1, or the food and beverage processing server 108. In one example embodiment, only an identifier for the recipe is made available for selection, such as a name of the recipe, a brand name of the recipe, and the like. In one example embodiment, a selected recipe is customized by a user (operation 324). For example, a user may specify a sweetener is added to the selected recipe. The customized recipe may be stored for future use by the food and beverage production system 100, and may be made available for selection during, for example, a future execution of operation 320. The customized recipe may be presented as an option to the user who customized the recipe or another authorized user identified by the user who customized the recipe.

In one example embodiment, a block (such as a compensation block) is added to the recipe blockchain identifying serving(s) of the recipe that are eligible for compensation, such as purchased servings, delivered servings, mixed servings, and the like (operation 328). The compensation block may be added by the appropriate mixing machine 104, the processing server 108, the user device 112, and the like. The compensation block may be added when the beverage is purchased, when the beverage is mixed, when the beverage is delivered, and the like.

In one example embodiment, the compensation due to the recipe creator, the recipe owner, the recipe licensee, and the like is determined based on the blockchain that includes the compensation information, such as the number of servings produced (operation 332).

Although certain examples are shown and described here, other variations exist and are within the scope of the invention. It will be appreciated by those of ordinary skill in the art that any arrangement, which is designed or arranged to achieve the same purpose, may be substituted for the specific embodiments shown. This application is intended to cover any adaptations or variations of the example embodiments of the invention described herein. It is intended that this invention be limited only by the claims, and the full scope of equivalents thereof.

### MODULES, COMPONENTS AND LOGIC

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network 115 (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

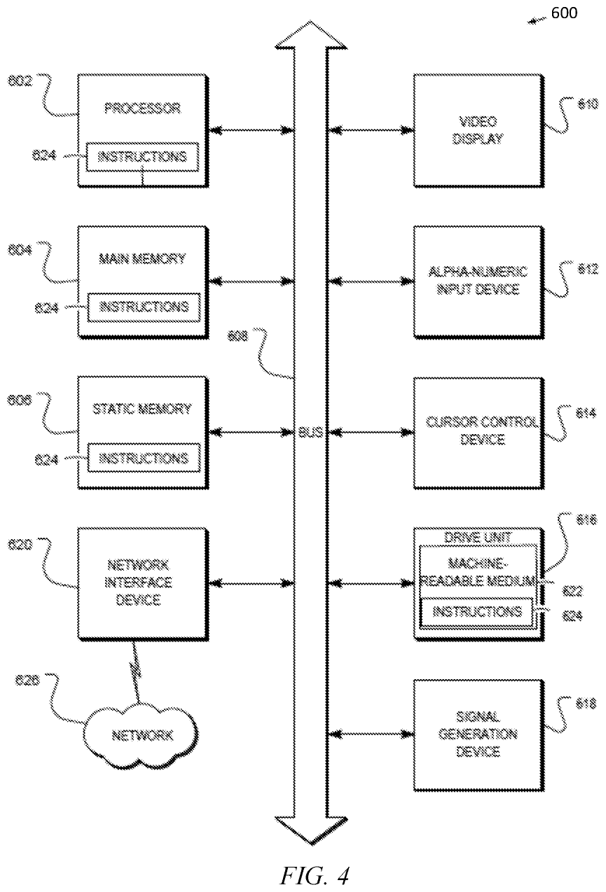

FIG. 4 is a block diagram of a machine within which instructions may be executed for causing the machine to perform any one or more of the methodologies discussed herein. In one example embodiment, an instance of the machine of FIG. 4 may be a component of the mixing machine 104, the user device 112, and/or the beverage processing server 108. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker) and a network interface device 620.

### Machine-Readable Medium

The drive unit 616 includes a machine-readable medium 622 on which is stored one or more sets of instructions 624 and data structures (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. Instructions 624 may also reside within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions 624 for execution by the machine and that cause the machine to perform any one or more of the methodologies of the present invention, or that is capable of storing, encoding or carrying data structures utilized by or associated with such instructions 624. The term “machine-readable medium” shall accordingly be taken to include, but not be limited to, solid-state memories, and optical and magnetic media. Specific examples of machine-readable media 622 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions 624 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method for mixing a beverage comprising:
obtaining a selection of a recipe from a user;
determining compensation for use of the recipe;
configuring a mixing machine based on the recipe;
mixing the beverage based on the recipe;
dispensing the beverage.
